(19) United States
(12) Patent Application Publication
(10) Pub. No.: US 2008/0218623 A1
(43) Pub. Date: Sep. 11, 2008

(54) ACCURATELY-ALIGNED CAMERA MODULE AND METHOD FOR MAKING SAME

(75) Inventors: SHIH-MIN LO, Tu-Cheng (TW); JEN-CHAO WANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/840,159

(22) Filed: Aug. 16, 2007

(30) Foreign Application Priority Data
Mar. 9, 2007 (CN) 200710200263.7

(51) Int. Cl. G03B 13/00

(52) U.S. Cl. 348/345; 348/E07.091

(57) ABSTRACT

A camera module includes an image sensor, a lens module and a holder. The holder defines a cavity, the cavity including a first receiving portion, with the lens module received therein, and a second receiving portion. The side surface of the image sensor tightly contacts the inner surface of the holder surrounding the second receiving portion. In the camera module, an optical center of the image sensor can keep accurately aligning with an optical center of the lens module. Accordingly, the camera module can keep good quality for imaging. A method for making the camera module is also provided.

### BACKGROUND

1. Technical Field

The present invention relates to camera modules and, particularly, to a camera module in which an optical center of an image sensor is accurately aligned with an optical center of a lens module and a method for making the camera module.

2. Description of Related Art

With the development of the optical imaging technology, camera modules are becoming widely used in electronic devices, such as digital cameras and mobile phones.

FIG. 3 shows a camera module 1 using a chip scale package (CSP) image sensor 3, according to a related article of technology. The camera module 1 includes a holder 2, an image sensor 3, a flexible printed circuit board 5, and a support board 6, which, usefully, may be strengthened/reinforced. The image sensor 3 is received at the bottom of the holder 2 and is electrically connected with the flexible printed circuit board 5 by a plurality of tin balls 4. The support board 6 is disposed on a surface of the flexible printed circuit board 5, facing away from the image sensor 3. The holder 2 has a plurality of positioning pins 7. The flexible printed circuit board 5 and the support board 6 has a plurality of positioning holes 8 (FIG. 4) corresponding aligned and shaped for receiving the positioning pins 7, referring to FIG. 3. The positioning holes 8 extend through the flexible printed circuit board 5 and the support board 6. The relative position of the image sensor 3 and the holder 2 can be fixed by inserting the positioning pins 7 into the positioning holes 8.

There are many disadvantages in the above-described camera module 1. First, the camera module 1, using the positioning pins 7, the positioning holes 8, and the support board 6 to fix the relative position of the image sensor 3 and the holder 2, costs additional money. Second, if the inner diameter of the positioning hole 8 is greater than the outer diameter of the positioning pin 7, there will be a gap between the positioning hole 8 and the positioning pin 7, and, as such, the relative position between the image sensor 3 and the holder 2 would therefore not be fixed accurately. Third, the image sensor 3 may become tilted as a result of heating of the flexible printed circuit board 5 or due to the tin balls 4 having different sizes.

What is needed, therefore, is a camera module which can accurately and permanently fix the relative position between the image sensor and the holder and, accordingly, keep an optical center of an image sensor accurately aligned with an optical center of a lens module in the camera module.

### SUMMARY

In accordance with one present embodiment, a camera module includes an image sensor, a lens module, and a holder. The holder defines a cavity, and the cavity includes a first receiving portion with the lens module received therein and a second receiving portion. The side surface of the image sensor tightly contacts the inner surface of the holder surrounding the second receiving portion.

In accordance with one present embodiment, a method for making a camera module includes the steps of: providing a holder defining a cavity, the cavity including a first receiving portion with a lens module received therein and a second receiving portion; and inserting an image sensor into the second receiving portion of the holder with the side surface of the image sensor in tight contact with the inner surface of the holder surrounding the second receiving portion.

### BRIEF DESCRIPTION OF THE DRAWING

Many aspects of the present camera module can be better understood with reference to the following drawings. The components in the drawing are not necessarily drawn to scale, the emphasis instead being placed upon clearly illustrating the principles of the present camera module. Moreover, in the drawing, like reference numerals designate corresponding parts throughout the several views.

FIG. 1 is a schematic, cross-sectional view of a camera module, according to a present embodiment;

FIG. 2 is a flow chart of a method for making the camera module of FIG. 1;

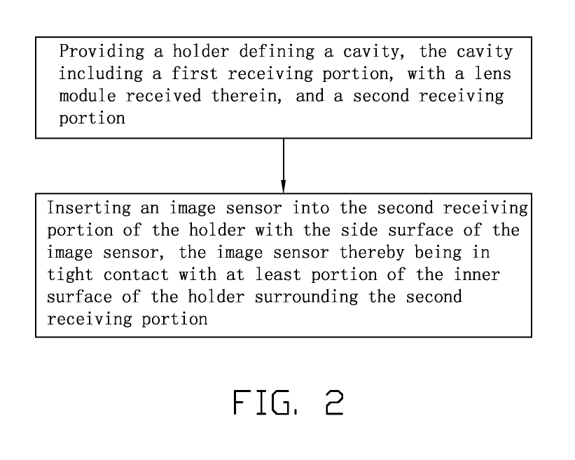

FIG. 3 is a schematic, cross-sectional view of a die assembly, according to a conventional camera module; and

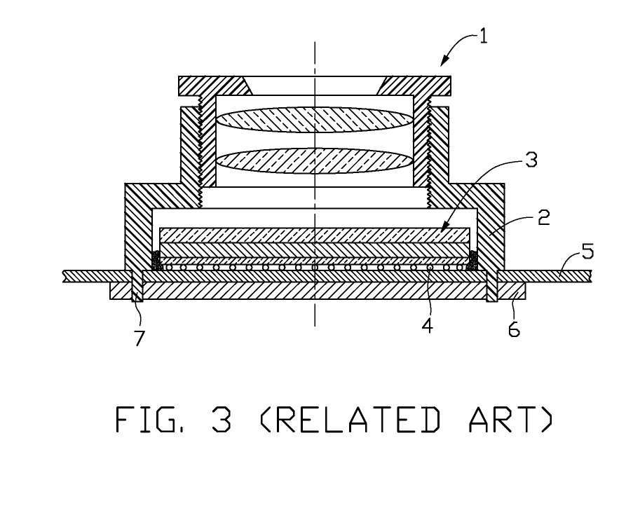

FIG. 4 is a schematic, plan view of a flexible printed circuit board of FIG. 3.

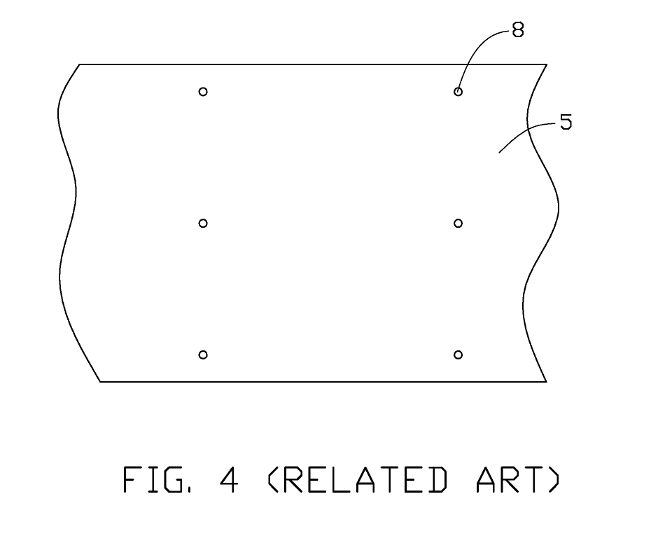

### DETAILED DESCRIPTION OF THE EMBODIMENTS

Embodiments will now be described in detail below, with reference to the drawings.

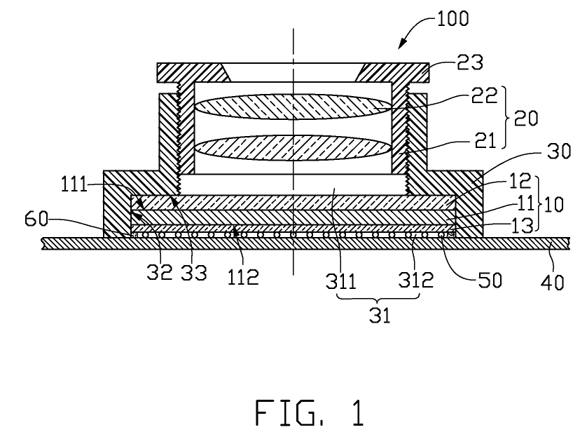

Referring to FIG. 1, a camera module 100, according to a present embodiment, is shown. The camera module 100 includes an image sensor 10, a lens module 20, and a holder 30.

The image sensor 10 is configured for electrically connecting to a circuit board 40 and can convert optical signals to digital image signals. The circuit board 40 can be a printed circuit board, such as a flexible printed circuit board. The image sensor 10 can, e.g., be a charge-coupled device (CCD) or a complementary metal oxide semiconductor device (CMOS). The image sensor 10 could further be selected from a ceramic leaded chip carrier (CLCC) package type image sensor, a plastic leaded chip carrier (PLCC) package type image sensor, or a chip scale package (CSP) type image sensor. Beneficially, the image sensor 10 is a chip scale package (CSP) type image sensor, the size of which can be accurately controlled.

In the present embodiment, the image sensor 10 is packaged using a chip scale package (CSP), and the image sensor 10 includes an image sensing wafer 11, a transparent layer 12, and a circuit layer 13 with a circuit pattern therein. The image sensing wafer 11 has a first surface 111, facing towards the lens module 20, and a second surface 112, facing away from the surface 111. The transparent layer 12 is attached to the first surface 111 of the image sensing wafer 11, and the circuit layer 13 is attached to the second surface 112. The transparent layer 12 can, advantageously, be an optical glass or plastic layer. The circuit layer 13 is electrically connected with the image sensing wafer 11, and it can, e.g., be a glass board with circuit formed therein. A plurality of solder pads, which are configured (i.e., structured and arranged) for electrically connecting the circuit board 40 with the image sensing wafer 11, are disposed on a surface of the circuit layer 13, facing away from the image sensing wafer 11. The solder pads can be electrically connected with the circuit board 40 by, e.g., a plurality of tin balls 50. It is to be understood that the balls 50 could instead be made, e.g., of a sufficiently conductive metal solder composition and still be within the scope of the present camera module 100.

The lens module 20 includes a barrel 21 and at least one lens 22 received therein. The barrel 21 has an external thread defined in an outer periphery thereof. The material of the barrel 21 can, usefully, be selected from the group consisting of polycarbonate, acrylonitrile-butadiene-styrene, and any combinations thereof. The barrel 21 can, beneficially, also have a focus-adjusting ring 23 arranged at an end of the barrel away from the image sensor 10, in order to allow the focus of the camera module 100 to be adjusted conveniently. Advantageously, the focus-adjusting ring 23 is integrally formed with the barrel 21. Moreover, in order to improve light transmittance in the lens 22, the lens 22 can further have anti-reflection coatings on its two surfaces facing along the direction of an optical axis of the barrel 21.

The holder 30 defines a cavity 31. The cavity 31 includes a first receiving portion 311 and a second receiving portion 312 communicating with the first receiving portion 311. The first receiving portion 311 is substantially cylindrical and is both shaped and sized (i.e., is, thus, properly structured/configured) for receiving the barrel 21. The inner surface of the holder 30 around the first receiving portion 311 has an internal thread configured for engaging with the external thread of the barrel 21. Accordingly, the barrel 21 can be selectably moved along a long/central axis of the cavity 31, in order to allow focus-adjustment of the camera module 100. The second receiving portion 312 has an approximately cuboid and/or a rectangular parallelepiped shape. The image sensor 10 is received in the second receiving portion 312 and is optically aligned with the lens 22.

In the present embodiment, the side surface of the image sensor 10 is in tight contact with the inner surface 32 (i.e., has at least a friction fit therewith) of the holder 30 surrounding the second receiving portion 312. As such, the relative position between the image sensor 10 and the holder 30 along a direction perpendicular to an optical axis can be effectively fixed and, thus, cannot be affected by any tilting of the circuit board 40 and/or a potential unevenness in the sizes/shapes of the tin balls 50. Accordingly, an optical center of the image sensor 10 can keep accurately aligned with an optical center of the lens module 20 and the camera module 100 can maintain high-quality imaging. Moreover, in order to fix the relative position between the image sensor 10 and the holder 30 along the direction of the optical axis, the top surface of the image sensor 10 can also be in contact with the inner surface 33 of the holder 30 on the top of the second receiving portion 312. In order to fix firmly the relative position between the image sensor 10 and the holder 30, in the present embodiment, a glue/adhesive 60 is opportunely disposed between the image sensor 10 and the holder 30.

It is understood that the tight contact of side surface of the image sensor 10 with the inner surface 32 of the holder 30 surrounding the second receiving portion 312 may involve tightly contact of all or part of the side surface of the image sensor 10 with the inner surface 32.

A method for making the camera module 100 is also provided. The method includes the steps of: providing a holder 30 defining a cavity 31, the cavity 31 including a first receiving portion 311, with a lens module 20 received therein, and a second receiving portion 312; and inserting an image sensor 10 into the second receiving portion 312 of the holder 30 with the side surface of the image sensor 10, the image sensor 10 thereby being in tight contact with at least portion of the inner surface 32 of the holder 30 surrounding the second receiving portion 312.

The method can, usefully, further include electrically connecting the image sensor 10 to a circuit board 40 before inserting the image sensor 10 into the second receiving portion 312 of the holder 30. The circuit board 40 can, e.g., be a printed circuit board, such as a flexible printed circuit board. The image sensor 10 has advantageously a size approximately equal to the size of the second receiving portion 312 of the holder 30, to thus promote a friction fit (i.e., tight contact) therebetween.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A camera module comprising:
an image sensor;
a lens module; and
a holder defining a cavity, the cavity including a first receiving portion, with the lens module received therein, and a second receiving portion, the side surface of the image sensor tightly contacting the inner surface of the holder surrounding the second receiving portion.

2. The camera module as claimed in claim 1, wherein the top surface of the image sensor contacts with the inner surface of the holder on the top of the second receiving portion.

3. The camera module as claimed in claim 1, wherein the image sensor is electrically connected to a circuit board and can convert optical signals to digital image signals.

4. The camera module as claimed in claim 3, wherein the circuit board is a flexible printed circuit board.

5. The camera module as claimed in claim 1, wherein the barrel is comprised of at least one material selected from the group consisting of polycarbonate and acrylonitrile-butadiene-styrene.

6. The camera module as claimed in claim 1, wherein the barrel has a focus-adjusting ring arranged at an end of the barrel located away from the image sensor.

7. The camera module as claimed in claim 6, wherein the focus-adjusting ring is integrally formed with the barrel.

8. The camera module as claimed in claim 1, wherein the at least one lens has an anti-reflection coating formed thereon.

9. The camera module as claimed in claim 1, wherein the side surface of the image sensor tightly contacts with all of the inner surface surrounding the second receiving portion.

10. The camera module as claimed in claim 1, wherein the side surface of the image sensor tightly contacts part of the inner surface surrounding the second receiving portion.

11. A method for making a camera module, comprising the steps of:
providing a lens module and a holder, the holder defining a cavity, the cavity including a first receiving portion and a second receiving portion, the lens module being received in the first receiving portion; and
inserting an image sensor into the second receiving portion of the holder with the side surface of the image sensor, the image sensor thereby tightly contacting with the inner surface of the holder surrounding the second receiving portion.

12. The method as claimed in claim 11, wherein the method further comprises electrically connecting the image sensor to a circuit board before inserting the image sensor into the second receiving portion of the holder.

13. The method as claimed in claim 12, wherein the circuit board is a flexible printed circuit board.

14. The method as claimed in claim 11, wherein the barrel is comprised of at least one material selected from the group consisting of polycarbonate and acrylonitrile-butadiene-styrene.

15. The method as claimed in claim 11, wherein the barrel has a focus-adjusting ring arranged at an end of the barrel located away from the image sensor.

16. The method as claimed in claim 15, wherein the focus-adjusting ring is integrally formed with the barrel.

17. The method as claimed in claim 11, wherein the at least one lens has an anti-reflection coating formed thereon.

18. The method as claimed in claim 11, wherein the side surface of the image sensor tightly contacts all of the inner surface surrounding the second receiving portion.

19. The method as claimed in claim 11, wherein the side surface of the image sensor tightly contacts part of the inner surface surrounding the second receiving portion.
